(19) United States
(12) Patent Application Publication
(10) Pub. No.: US 2007/0031626 A1
(43) Pub. Date: Feb. 8, 2007

(54) Connecting splice for connecting reel

(75) Inventor: Patrick Rome, El Paso, TX (US)

Correspondence Address: R WAYNE PRITCHARD, 300 EAST MAIN, SUITE 1240, EL PASO, TX, 79901, US

(73) Assignee: Electro Reel Components, L.L.C., El Paso, TX (US)

(21) Appl. No.: 11/499,032

(22) Filed: Aug. 4, 2006

Related U.S. Application Data
(60) Provisional application No. 60/705,779, filed on Aug. 5, 2005.

(51) Int. Cl. B32B 33/00

(52) U.S. Cl. 428/40.1

(57) ABSTRACT

A splice for use in connecting the trailing end of one reel of carrier tape containing surface mount devices to the leading edge of another reel containing same.

### BACKGROUND OF THE INVENTION

1. Field of the Invention

This invention relates to a splice for reels of tape which carry surface mounted devices.

2. Description of the Prior Art

Surface mounted technology (“SMT”) is a method for constructing electronic circuits in which the components are mounted directly onto the surface of the printed circuit board “TCB”). Electronic components utilized in connection with SMT are referred to as surface mount devices (“SMD”). In the electronic industry, use of SMD's has largely replaced the previous construction method of fitting components with wire leads into holes in the circuit board, referred to as through hole technology or “THT.” SMT offers the advantage over previous technology in that it utilizes smaller components, allows use of both sides of the PCB, there is no need to drill holes for wire leads, and it permits the use of simpler, more automated assembly.

Surface mount devices are usually smaller that their leaded counterparts and are designed to be handled by machines rather than humans. To facilitate handling and ease of use, the electronic industry has defined a collection of standard sizes for SMD's such as resistors, capacitors, inductors, semiconductors and integrated circuits. Placement machines can pick and place thousands of components like those mentioned above, each hour, with a very high degree of accuracy. To achieve this performance, the component delivery system must be capable of feeding parts a high speeds in a consistent orientation. Additionally, it is critical that the components be protected from damage during shipment, handling and placement. The preferred method of supplying SMD's today is tape and reel. Tape and reel is a process of loading SMD's into individual pockets contained on what is known as pocket or carrier tape. The carrier tape typically has holes along one edge which align with the handling requirements of the component delivery system. The components are sealed in the carrier tape with a cover tape. The carrier tape is wound around a reel for convenient handling and transport.

Although it is intuitively obvious that a bigger reel will hold more tape and consequently more SMD's, limitations placed on machinery restrict how big the reel can be. As a result, it is necessary for the smooth and continuous operation of the component delivery system to have a way of splicing the ends of one reel to the beginning of another. Equally as obvious is the fact that the cheapest and easiest to use splice will be the splice most preferred in the industry.

As true as the famous movie line, “If you build it, they will come”, it is likewise true that if you build the cheapest and easiest to use splice, the electronic industry will buy it. Over the years there have been many who have tried and failed at inventing a cheap and easy to use splice. Even before the advent of SMD technology, splices were commonly used for piecing together film. For example, in 1969, Marvin Kapilow obtained a patent for a “Splice Patch for Super 8 Film”, U.S. Pat. No. 3,475,263 and in 1975, Yoritaro Takahashi obtained a patent for a “Film Splice Patch”, U.S. Pat. No. 3,914,491. Both the Takahashi as well as Kapilow patents disclose the use of an alignment tool so that the splicing tape would be properly aligned with the sprockets of the film. In the setting of the SMD industry, the use of any type of alignment tool would slow the overall process down and increases the costs associated with such process.

In 1971, Albert Zemek obtained a patent for a “Belted Axial Lead Electronic Component Splicing Clip”, U.S. Pat. No. 3,571,862. As can be seen from the figures disclosed in such patent, the electrical components at the time of the Zemek patent still contained leads. To accommodate the leads, the Zemek splice employs a series of angled ends which would be first folded up and then over the carrier tape between the leads of the electrical components. The Zemek splice would not function with the current style of carrier tape at all in that there is no space in such carrier tape for the folded angled ends.

In 1979, Nishioka obtained a patent for a “Device for Connecting Tapes Carrying Tape-Fed Components”, U.S. Pat. No. 4,168,794. As with both the Takahashi as well as Kapilow patents, the splice disclosed in the Nishioka patent needed an alignment tool. Obviously understanding the expense of the alignment tools of the prior art, in 1997, Rainer Schulze-Kahlayss obtained a patent for a “Splicing Aid for Connecting Component Belts”, U.S. Pat. No. 5,643,401. The Schulze-Kahayss splicing aid while less complex (less expensive) than the prior art still recognized the need for an alignment tool.

Apparently not appreciating the need for simplicity, in 2000 and 2002, Asai, et al, obtained patents for a “Tape Connecting Method, Member and Tool”, U.S. Pat. No. 6,073,334 and U.S. Pat. No. 6,364,567, both of which employed the use of metal clips with a crimping tool. Trying to simply things a bit, in 2002, Teruyki Kato obtained a patent for a “Connection Tape for Square Hole Punch Carrier Type Taping and Method of Manufacturing Connecting Tape”, U.S. Pat. No. 6,428,888, in which Kato departed from the use of a crimping tool and employed the use of a “jig” to align the splice. In U.S. Pat. No. 6,878,424 and US Pub. No. 2004-0011701 2005, both to Sumida, et al, for “Connecting Member for Connecting Carrier Tapes and Carrier Tape Connecting Method Using this Connecting Member”, U.S. Pat. No. 6,878,424, Sumida attempted to simply the splice but still had to employ the use of positioning pins and or a “reference band” to properly align the splice with the carrier tape.

Notwithstanding the various patents disclosed above, there are basically three (3) systems currently being used in the industry for splicing tape, two of which are achieved through assembly aids and one of which is achieved manually. First, a metal splicing clip, such as that disclosed in the Asai patents, is crimped onto the leading and trailing edges of two reels of tape using a crimping tool that properly aligns the tape sprockets and places a rectangular adhesive strip across the surface of the metal clip. The metal clip in this type of splicing is absolutely necessary for proper alignment of the sprockets. Panasonic, VS Solution and Shenzhen Comofaje Technology Co., Ltd disclose the foregoing splice in their most recent promotional literature. While the use of a metal clip for properly alignment of the sprockets is effective, it drives the cost of the splice up both in terms of the cost of the metal clip as well as the additional labor needed crimp such clip.

As second splice currently used in the market is an expensive set of rectangular adhesive strips that are pre-assembled onto a plastic alignment tool. As with use of metal clip discussed above, the utilization of any kind of alignment aid increases the overall cost of the splice as well as the labor associated with the use of such splice. A third type of splice in use today alleviates the need for an alignment tool but requires skilled operators to place two individual rectangular adhesive strips across the carrier tape. Skill of the operators is necessary to insure proper spacing so that the carrier tape will feed correctly.

### SUMMARY OF THE INVENTION

It is, therefore, an object of the present invention ro provide an inexpensive, easy to use adhesive splice for achieving a separate top and bottom connection of the component carrying tape, that is configured to be used without any sort of alignment or assembly tool. Other objects and advantages of the present invention will become apparent from the following detailed description, when viewed in conjunction with the accompanying drawings, which set forth certain embodiments of the invention.

### BRIEF DESCRIPTION OF THE DRAWINGS

FIG. 1 is an illustration of typical SMD components.

FIG. 2 is an illustration of typical reel containing tape with SMD;s.

FIG. 3 is an illustration of a typical piece of carrier tape showing the SMD's along with the alignment sprockets.

FIGS. 4 and 4a illustrate two of the alternative embodiments of the splice of the present invention before use.

FIG. 5 illustrates placement of the splice of the current invention onto the carrier tape.

FIG. 6 depicts the splice of the current invention as well as how the splice handling strip[is removed from the splice.

FIG. 7 depicts the three steps in application of the splice of the present invention

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

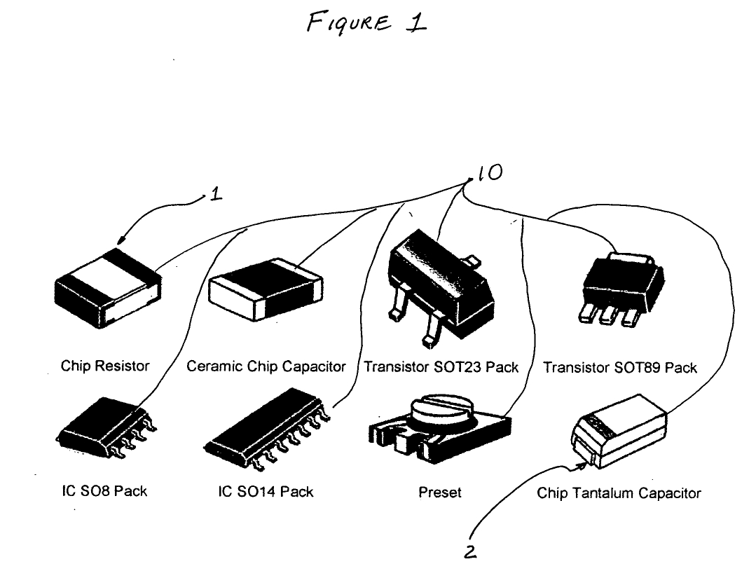

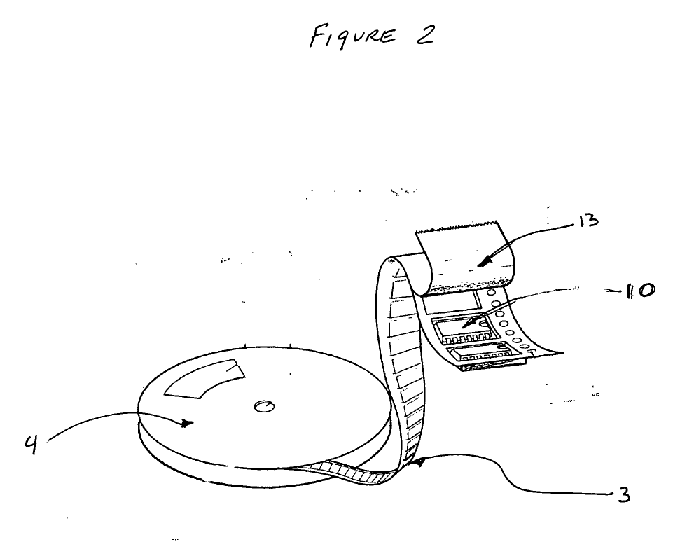

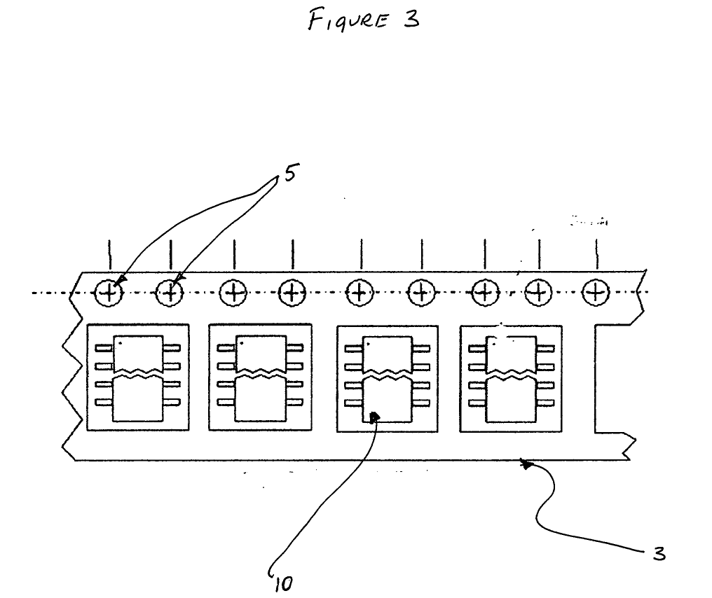

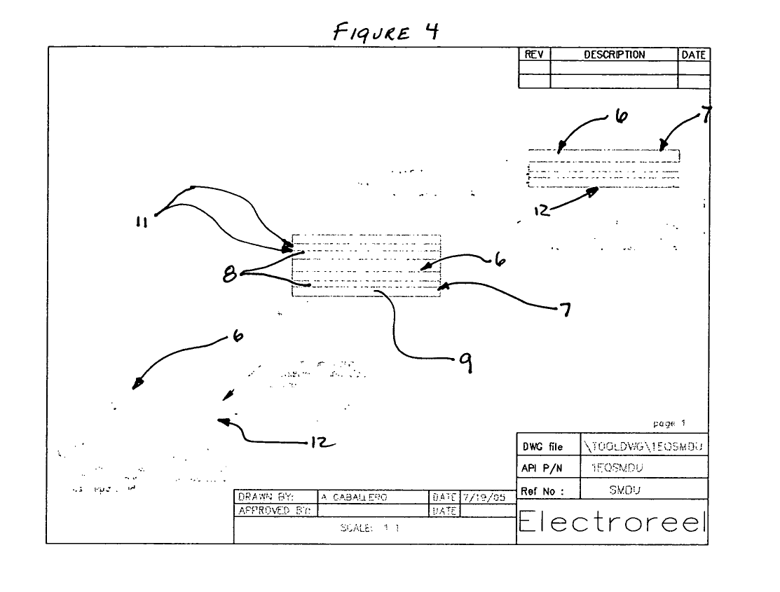

As shown in FIG. 1, SMD components [10] encompass a broad range of electrical devices such as capacitors [1] or resistors [2]. These SMD's are placed, as shown in FIG. 2, onto a tape [3] referred to as a carrier tape, covered with a cover tape [13]. and then wound on a reel [4]. FIG. 3 depicts a typical carrier tape shown the alignment holes [5] found along one side of such tape.

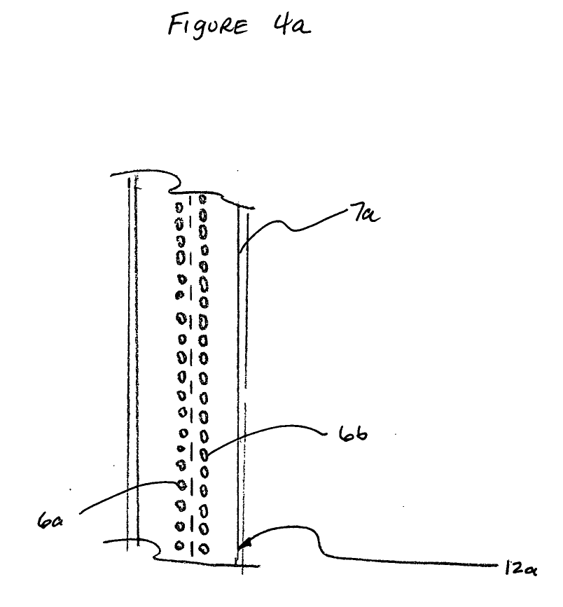

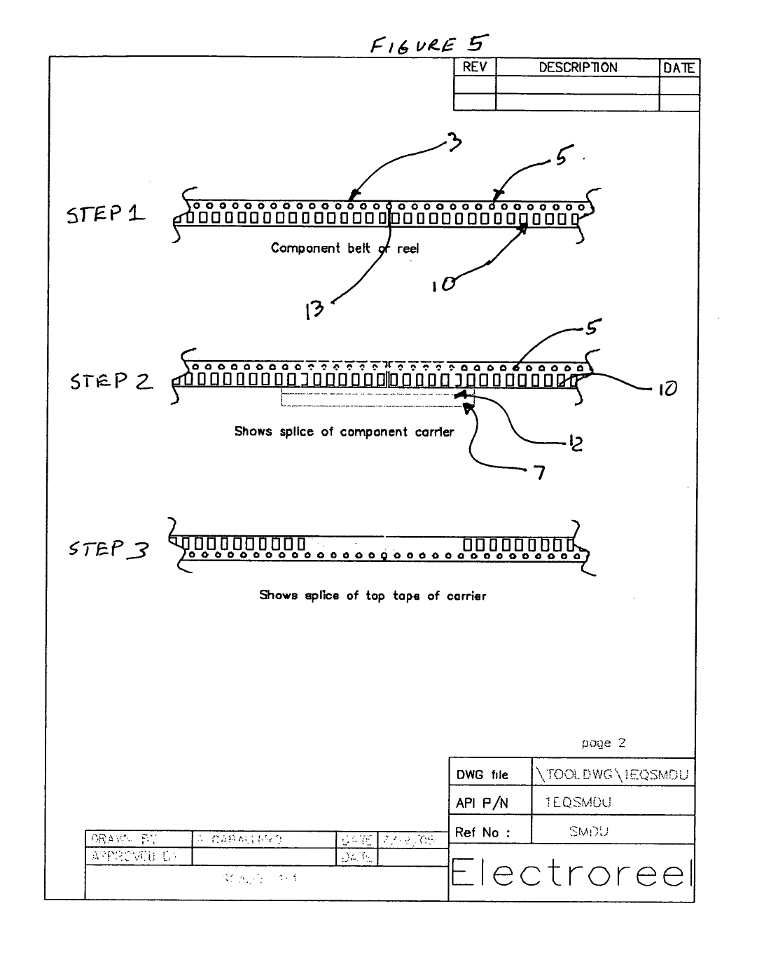

The splice of the present invention [12] is shown in FIGS. 4, 4a, 5, 6 and 7. Although any suitably flexible material may be used for the splice, the material must of strength and flexibility at least equal to that of the carrier tape [3] or cover tape [13]. While, as shown in FIG. 4, the splice [12] of the present invention is designed to be double sided, meaning one surface of the splice adheres to the top side of the carrier tape [3] while one side of the splice [12] will adhere to the bottom of the carrier tape [3], the splice could easily be made to be single sided. As further shown in FIG. 4, the splice of the present invention [12] contains sprockets [6] along one edge, which will align with the holes [5] contained on the carrier tape [3]. As shown in FIG. 5, the double sided splice [12] is basically folded along its center line over the edge of the carrier tape [3] away from the alignment holes [5], aligning the sprockets with the alignment holes [5] of the carrier tape [3]. Another embodiment of the splice of the present invention is shown in FIG. 4a where the sprockets [6a and 6b] are positioned along each side of the centerline of the splice [12a]. In this configuration, the double sided splice [12a] is folded over the edge of the carrier tape [3] which contains the alignment holes [5], aligning the sprockets [61 and 6b] with the alignment holes [5] and affxing the adhesive backing [7a] to the carrier tape [3].

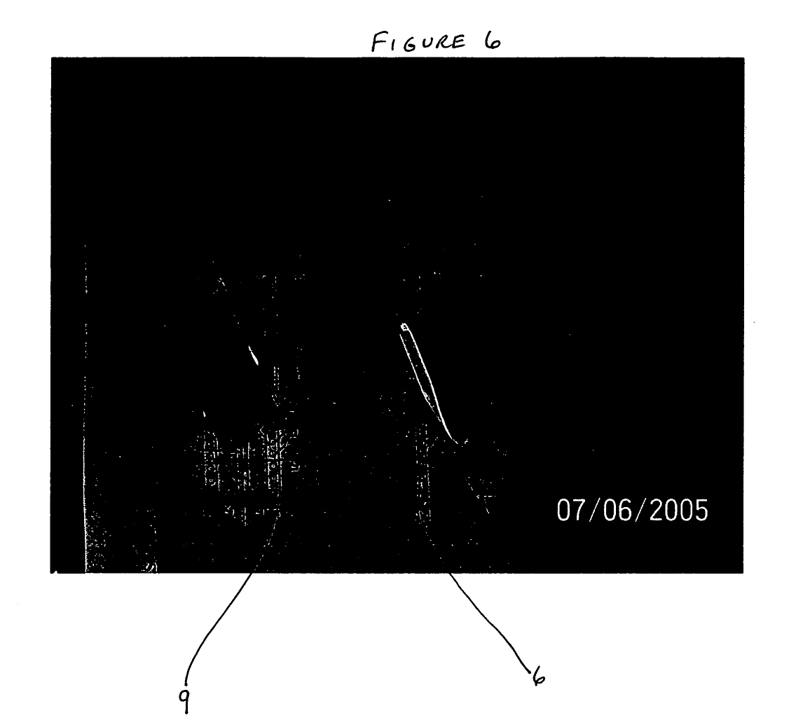

Any number or geometries of sprockets may be used as long as there is sufficient alignment with the alignment holes [5] of the carrier tape [3]. FIGS. 4 and 6 show the adhesive backing [7] attached to the splice [12] and depict how multiple splices [8] may be manufactured from a single piece of raw material [9]. The adhesive backing [7] may have single or multiple cuts or perforations [11] to allow for easier removal. Although not necessary, the splice [12 and 12a] of the present invention could contain a pre-marked center line fo facilitate easier folding.

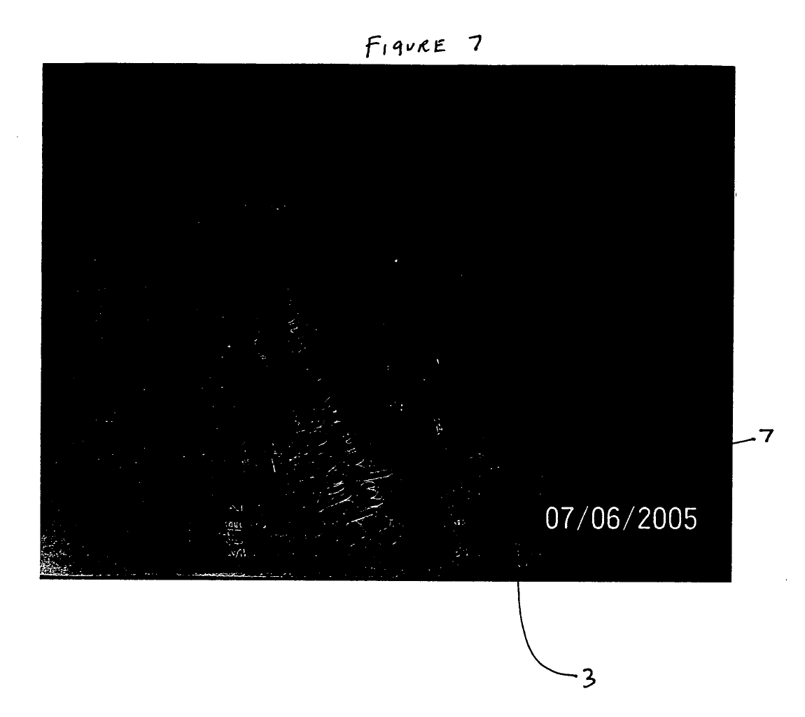

FIGS. 5 and 7 illustrate actual application of the splice [12] to a carrier tape [3]. The first step is to match up the ends [13] of the carrier tape [3] to be spliced. Second, the splice [12] is place over the ends [13] making sure that the sprockets [6] align properly with the holes [5] on the carrier tape [3]. The third step is to remove the adhesive backing [7] from the splice [12] and fold the splice [12] along its centerline over the edge of the carrier tape [3] away from the alignment holes [3], making sure that the sprockets [6] properly align with such holes. To facilitate easy removal of the adhesive backing [7], such adhesive backing can be made with perforations or cuts. To verify placement of the splice [12], the splice can be of a color different from the carrier tape [3]. To apply the splice [12a] shown in FIG. 4a, the same procedure as outlined above is utilized except that the splice [12a] is folded along its centerline over the edge of the carrier tape [3] closest to the alignment holes [5].

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A splice for use in connecting the trailing end of one reel of carrier tape containing surface mount devices to the leading edge of another reel containing same, said splice comprising:
a strip of suitably flexible material;
an adhesive backing to said strip; and
a plurality of substantially equally spaced and sized sprockets along one edge of said strip.

2. The splice as in claim 1 wherein the color of said splice is different than that of the carrier tape.

3. The splice as in claim 1 wherein a predetermined and marked folding line is provided along the center line of said splice.

4. The splice as in claim 1 wherein the adhesive backing contains one or more cuts or perforations to facilitate easy removal from said splice.

5. A splice for use in connecting the trailing end of one reel of carrier tape containing surface mount devices to the leading edge of another reel containing same, said splice comprising:
a strip of suitably flexible material;
an adhesive backing to said strip; and
a plurality of substantially equally spaced and sized openings perpendicularly juxtaposed along the center line of said strip.

6. The splice as in claim 5 wherein the color of said splice is different than that of the carrier tape.

7. The splice as in claim 5 wherein ta predetermined and marked folding line is provided along the center line of said splice.

8. The splice as in claim 5 wherein the adhesive backing contains one or more cuts or perforations to facilitate easy removal from said splice.
